(19) United States
(12) Patent Application Publication
(10) Pub. No.: US 2024/0217551 A1
(43) Pub. Date: Jul. 4, 2024

(54) TRADING OFF COMFORT IN AUTONOMOUS VEHICLE PLANNING AND CONTROLS

(71) Applicant: GM Cruise Holdings LLC, San Francisco, CA (US)

(72) Inventors: Shad Laws, Redwood City, CA (US); Martin Sehr, Kensington, CA (US); Rushil Goradia, San Francisco, CA (US); Dogan Cohen-Gidon, Seattle, WA (US)

(73) Assignee: GM Cruise Holdings LLC, San Francisco, CA (US)

(21) Appl. No.: 18/150,139

(22) Filed: Jan. 4, 2023

(51) Int. Cl. B60W 60/00

(52) U.S. Cl. CPC B60W 60/0013; B60W 2520/105; B60W 2555/00; B60W 2555/20

(57) ABSTRACT

Systems and methods for measuring passenger comfort and trading off passenger comfort with other metrics in autonomous vehicle planning and control. Perception of kinematic comfort relative to acceleration can vary depending on the frequency of acceleration. Systems and methods are provided to use the relationship between kinematic comfort and acceleration to introduce a cost on the ratio between acceleration and jerk. In various examples, the resulting cost can be traded off against other cost terms such as obstacle buffers and reference tracking constraints. Autonomous vehicle planning and control problem formulations can be encoded to include a direct tradeoff between both lateral and longitudinal comfort metrics and other variables.

### BACKGROUND

### 1. Technical Field

The present disclosure generally relates to vehicle comfort and, more specifically, to comfort considerations in vehicle planning and controls.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles. When driving around, autonomous vehicles, like other vehicles, can drive over road debris that can damage the vehicle tires.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an autonomous vehicle having planning and control stacks for planning vehicle path, according to some examples of the present disclosure;

FIG. 2 is a block diagram illustrating an example of a system for trading off comfort with other factors in planning and control modules, according to some examples of the present disclosure;

FIG. 3 is an example showing a planning layer vehicle path and a control layer vehicle path, according to various examples of the present disclosure;

FIGS. 4A and 4B are flowcharts showing methods for trading off comfort with other factors in the planning layer and control layer, according to various examples of the present disclosure;

FIG. 5 illustrates an example system environment that can be used to facilitate autonomous vehicle (AV) dispatch and operations, according to some aspects of the disclosed technology;

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

### Overview

Autonomous vehicles provide driverless ride services, allowing a user to request a ride from a pick-up location to a destination location. With the autonomous driving features of the autonomous vehicle, the user is a passenger in the vehicle and there is no human driver. The autonomous vehicle can navigate from the pick-up location to the drop-off location with no or little user input. To improve ride services provided by autonomous vehicles, it is important to consider ride comfort for rides provided by autonomous vehicles (“autonomous vehicle rides”). Improved methods are provided for considering ride comfort in planning and control stacks.

Systems and methods are provided herein to measure passenger comfort and to trade off passenger comfort with other metrics in autonomous vehicle planning and controls. Perception of kinematic comfort relative to acceleration can vary depending on the frequency of acceleration. In some examples, perception of kinematic comfort relative to acceleration can be weighted depending on excitation frequency. Systems and methods are provided to use the relationship between kinematic comfort and acceleration to introduce a cost on the ratio between acceleration and jerk. The cost can be specified by the desired cut off frequency. In various examples, the resulting comfort cost can be traded off against other cost terms such as obstacle buffers and reference tracking constraints. Autonomous vehicle planning and controls problem formulations can be encoded to include a direct tradeoff between both lateral and longitudinal comfort metrics and other variables. In some examples, a human comfort proxy is used for an explicit tradeoff between comfort and other variables.

### Example Vehicle for Trading off Comfort and Other Factors in Planning and Controls

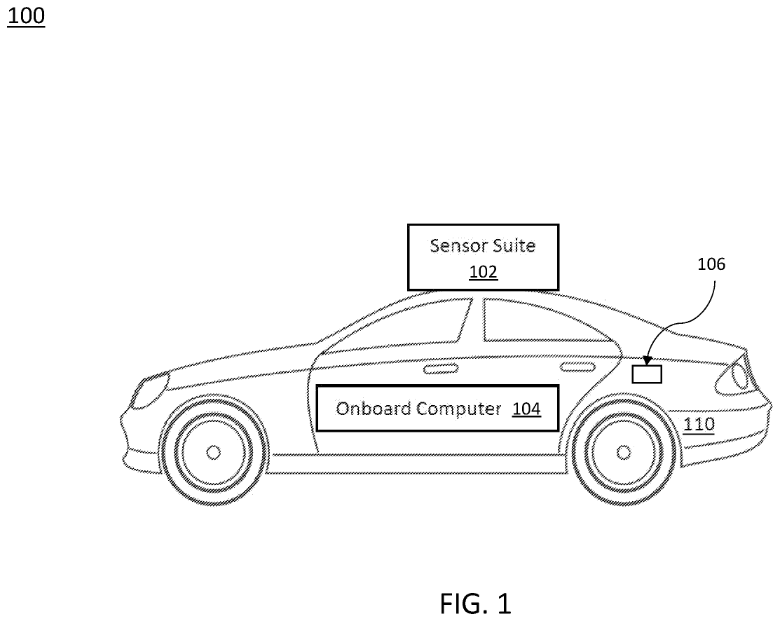

FIG. 1 illustrates an autonomous vehicle 110 having planning and control stacks 106 that trade off ride comfort metrics with other factors, according to some examples of the present disclosure. The autonomous vehicle 110 includes a sensor suite 102 and an onboard computer 104. In various implementations, the autonomous vehicle 110 uses sensor information from the sensor suite 102 to determine its location, to navigate traffic, to sense and avoid obstacles, and to sense its surroundings. According to various implementations, the autonomous vehicle 110 is part of a fleet of vehicles for picking up passengers and/or packages and driving to selected destinations. In some examples, the autonomous vehicle 110 can connect with a central computer to download vehicle updates, maps, and other vehicle data. The planning and control stacks 106 use vehicle sensor data, such as data from the sensor suite 102, as well as other accelerometer and/or sensor data, to determine a vehicle path as described herein.

The sensor suite 102 includes localization and driving sensors. For example, the sensor suite 102 may include one or more of photodetectors, cameras, radio detection and ranging (RADAR), sound navigation and ranging (SONAR), LIDAR, Global Positioning System (GPS), inertial measurement units (IMUs), accelerometers, microphones, strain gauges, pressure monitors, barometers, thermometers, altimeters, wheel speed sensors, and a computer vision system. The sensor suite 102 continuously monitors the autonomous vehicle's environment. In particular, the sensor suite 102 can be used to identify information and determine various factors regarding an autonomous vehicle's environment. In some examples, data from the sensor suite 102 can be used to update a map with information used to develop layers with waypoints identifying various detected items, such as areas with high quantities of road debris, and/or areas with metal infrastructure. Additionally, sensor suite 102 data can provide localized traffic information, ongoing road work information, and current road condition information. In this way, sensor suite 102 data from many autonomous vehicles can continually provide feedback to the mapping system and the high fidelity map can be updated as more and more information is gathered.

In various examples, the sensor suite 102 includes cameras implemented using high-resolution imagers with fixed mounting and field of view. In further examples, the sensor suite 102 includes LIDARs implemented using scanning LIDARs. Scanning LIDARs have a dynamically configurable field of view that provides a point cloud of the region intended to scan. In still further examples, the sensor suite 102 includes RADARs implemented using scanning RADARS with dynamically configurable field of view.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. Additionally, the onboard computer 104 processes data for the planning and control stacks 106, and can use sensor suite 102 data for generating a vehicle path and trading off comfort with other factors. In some examples, the onboard computer 104 checks for vehicle updates from a central computer or other secure access point. In some examples, a vehicle sensor log receives and stores processed sensed sensor suite 102 data from the onboard computer 104. In some examples, a vehicle sensor log receives sensor suite 102 data from the sensor suite 102. In some implementations described herein, the autonomous vehicle 110 includes sensors inside the vehicle. In some examples, the autonomous vehicle 110 includes one or more cameras inside the vehicle. The cameras can be used to detect items or people inside the vehicle. In some examples, the autonomous vehicle 110 includes one or more weight sensors inside the vehicle, which can be used to detect items or people inside the vehicle. In some examples, the interior sensors can be used to detect passengers inside the vehicle. Additionally, based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some implementations, the onboard computer 104 is a general purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

According to various implementations, the autonomous driving system 100 of FIG. 1 functions to enable an autonomous vehicle 110 to modify and/or set a driving behavior in response to parameters set by vehicle passengers (e.g., via a passenger interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences.

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, a bicycle, a scooter, a tractor, a lawn mower, a commercial vehicle, an airport vehicle, or a utility vehicle. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

Example System for Trading Off Comfort with Other Factors

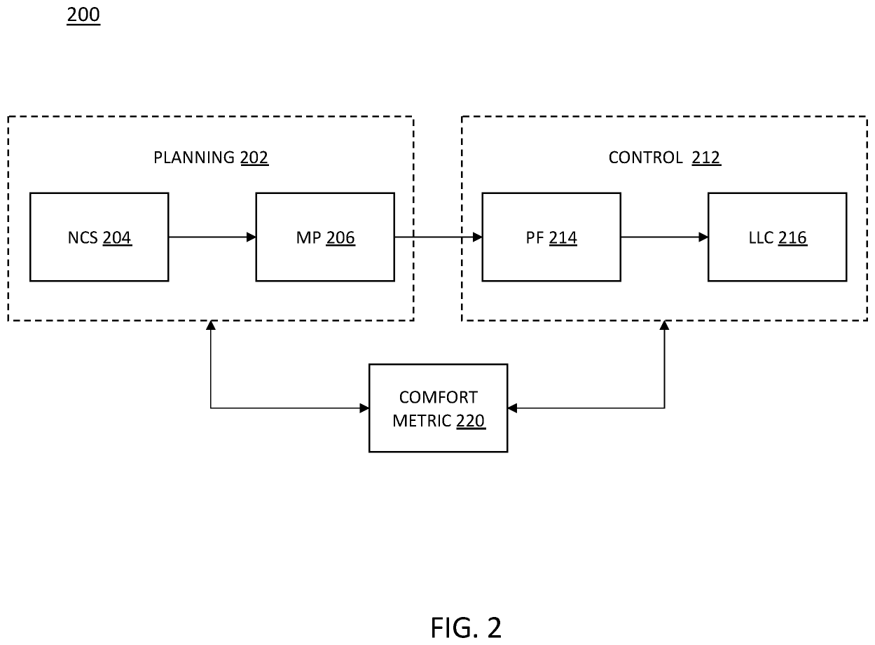

FIG. 2 is a block diagram illustrating an example of a system 200 for trading off comfort with other factors in planning and control modules, according to some examples of the present disclosure. While the diagram shows several specific modules for performing various functions, the functions of the planning and control layers can be performed by different modules, and each module can perform different functions. The system 200 illustrates one example for planning a vehicle trajectory and implementing controls such that the vehicle drives along the trajectory.

The NCS module 204 can be a planning layer 202 module that incorporates many factors in planning a vehicle's path. In some examples, factors considered by the NCS module 204 include longitudinal acceleration and lateral acceleration. The NCS module 204 can coarsely discretize the path for planning. Additionally, the NCS module 204 can consider vehicle capabilities, known obstacles, and environmental conditions. Known obstacles include static obstacles. In some examples, the NCS can evaluate pre-defined maneuvers such as a hard brake along a known reference curvature. In some examples, the planning layer 202 can include a trajectory proposal generator, which uses a nonlinear model to couple lateral and longitudinal state elements such as curvature, velocity, and longitudinal acceleration.

The MP module 206 can receive NCS module 204 output, and follows NCS references. Additionally, the MP module 206 can incorporate urgent obstacles, lateral motion with respect to a selected reference velocity, and lateral and longitudinal motion with respect to a selected reference curvature. In some examples, lateral and longitudinal motion are coupled. In some examples, the MP module 206 enforces decoupled constraints on lateral and longitudinal acceleration. For instance, the MP module 206 can include direct asymmetric upper and lower limits on longitudinal acceleration. In some examples, the MP module 206 can include indirect symmetric limits on lateral acceleration (aₗₐₜ(t)=v(t)²/R(t)). In some examples, a lateral acceleration limit is enforced indirectly via velocity. In some examples, an absolute curvature limit is enforced. In some examples, the MP module 206 incorporates lateral and longitudinal acceleration in planning a path for the vehicle. In some examples, the MP module 206 can include a longitudinal planner. In some examples, the MP module 206 includes coupled constraints between velocity and acceleration to closely approximate given acceleration limits. The approximation can use a polygon with the number of edges determined based on the results of a friction envelope analysis.

The output from the MP module 206 can be input to the control layer 212. In particular, the MP module 206 output is received at a PF module 214. The PF module 214 can limit velocity and acceleration and follows the MP module 206 output path. In some examples, the velocity and acceleration constraints are implemented as joint linear constraints. Additionally, the PF module 214 includes a lateral controller to limit lateral acceleration. In some examples, the lateral acceleration limit is expressed as a constraint on commanded curvature.

The output from the PF module 214 can be input to the LLC module 216. The LLC module 216 receives the PF module 214 output including a local path plan including target curvature and speed. The LLC module 216 includes a lookup table, for looking up steering and other low level controls based on the input data. In some examples, the LLC includes road pitch compensation data. The LLC module 216 outputs actuator commands.

According to various implementations, the various planning and control layer modules include comfort metrics as a factor considered in vehicle path planning and controls. In general, a human comfort measure can be based on different acceleration profiles. As shown in FIG. 2, a comfort metric can be calculated at the comfort metric module 220. The comfort metric module 220 can receive acceleration data from the planning layer 202. Based on the received data, the comfort metric module 220 can calculate a comfort metric and output the comfort metric to the planning layer 202. Similarly, the comfort metric module 220 can receive acceleration data from the control layer 212. Based on the received data, the comfort metric module 220 can calculate a comfort metric and output the comfort metric to the control layer 212. In particular, human comfort can be determined based on the frequency response of acceleration. Acceleration at various frequencies results in various levels of human comfort in the vehicle. In some examples, frequency studies are quasi-static, with acceleration at some frequencies being less comfortable than acceleration at other frequencies. Additionally, the derivative of acceleration (i.e., jerk) indicates how acceleration changes over time. Acceleration and jerk are used together to determine a kinematic comfort metric that is used as a proxy for human comfort. In some examples, acceleration and jerk are set at a selected ratio. In one example, the jerk-to-acceleration ratio is:

$${jerk}^{2} / {acceleration}^{2} = 6.3$$

The kinematic comfort metric can be traded off against other factors or metrics in planning a vehicle path, formulating a vehicle plan, or controlling vehicle behavior. In some examples, in optimization, the trade off is set based on weights that correspond to the various metrics and/or factors. In some examples, the comfort metric is a constraint used in the optimization. The kinematic comfort metric can be applied in both planning layers (e.g., planning layer 202) and in control layers (e.g., control layer 212).

In some implementations, in the planning layer, many factors are considered in planning a path for the vehicle. Factors include obstacles, lane departures, proximity to pedestrians, proximity to other road users, general speed, and the speed at which a vehicle takes a turn. In some examples, the proximity to a road user can be weighed against comfort, with the planning layer increasing the distance from a road user at the expense of kinematic comfort (meaning the vehicle occupant may be slightly less comfortable than if the vehicle drove close to the road user). However, the planning layer can also consider that a vehicle occupant may be uncomfortable if the vehicle drives too close to a road user, decreasing occupant comfort. In general, the optimizations seek a balance between competing factors that do not impact safety. Similarly, if the vehicle swerves to increase distance from an obstacle, the vehicle speed while swerving is considered, as an aggressive swerve can be very uncomfortable for a vehicle occupant. The various factors can all interact and be weighted differently by the planning layer to ensure comfort for the vehicle occupant and other road users. In general, favoring a first factor can be considered a cost on a second factor.

In some implementations, in the control layer, comfort is traded off with tracking error. Additionally, comfort can be traded off with tracking damping. Tracking damping refers to damping the tracking of the reference. For example, if the reference indicates a large acceleration and jerk, the response is dampened to have a smaller acceleration and smaller jerk, in exchange for improved comfort—here, the damping effect is the solution not tracking the reference. In particular, the control layer receives a reference path from the planning layer and tracks the reference path as closely as possible, with any deviation from the reference path considered a tracking error. The control layer also determines a comfort score for the actual path. In some examples, the control layer reviews a few seconds of upcoming driving data. For the upcoming duration, the control layer reviews the kinematic quantities of the vehicle at a selected discretization (i.e., at a selected sampling rate). For example, the control layer can review position, velocity, acceleration, jerk, and frequency information to determine tracking error. Additionally, the control layer can use these measurements to determine a kinematic comfort score. In some examples, the kinematic comfort score is determined based on frequency information including acceleration and jerk. In various implementations, the control layer does not receive information regarding obstacles or other traffic participants and follows the path determined by the planning layer.

In general, the control layer aims to minimize the tracking error. However, the aggressiveness with which the vehicle responds to a tracking error can affect comfort metrics. In some examples, potholes, wind, uneven road surfaces, and other road disturbances can cause tracking error. However, for example, a jerk in steering to correct for a tracking error would result in discomfort for a vehicle occupant. Thus, the control layer can consider the comfort score when minimizing the tracking error, so as to not cause a decrease in comfort when adjusting for a tracking error.

According to some implementations, kinematic comfort can be directly encoded using a cost ratio, thereby reducing the number of factors adjusted in trading off kinematic comfort. In some examples, when a vehicle is following a lateral path, re-entry error can be traded off with comfort. Similarly, in some examples, when a vehicle is following a longitudinal path, re-entry error can be traded off with comfort. In some examples, a filter for trading off acceleration with kinematic comfort is a high pass filter, with lower acceleration frequencies filtered out. For instance, the filter can have a corner frequency of about 0.4 Hz. In general, the vehicle response is the inverse of the cost filter.

Thus, while the planning layer includes many factors that can be weighed and adjusted including comfort, the control layer balances tracking error and tracking damping against comfort.

### Example Path for Planning Layer and Control Layer

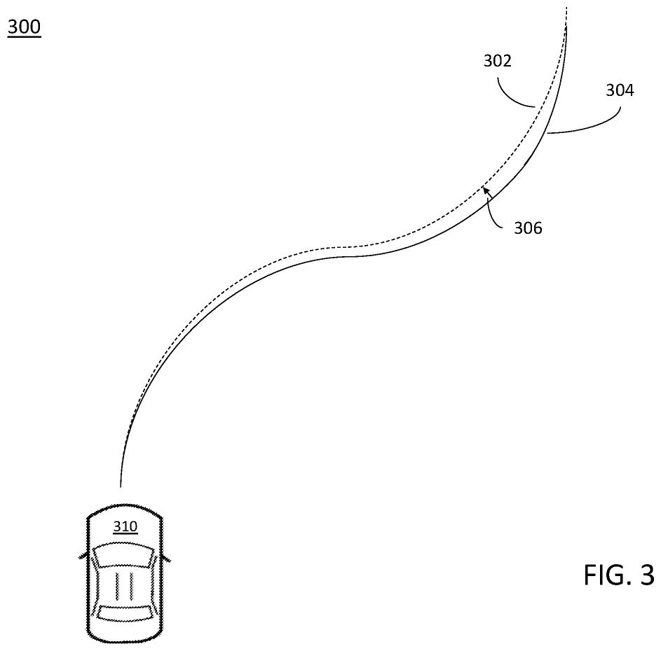

FIG. 3 is an example 300 showing a planning layer vehicle path and a control layer vehicle path, according to various examples of the present disclosure. In particular, FIG. 3 shows a planning layer path 302 planned out by the planning layer for the vehicle 310. Additionally, FIG. 3 shows a path 304 determined by the control layer. The control layer path 304 deviates from the planning layer path, as the vehicle turns to the right, as illustrated by the arrow 306. According to various examples, the control layer of the vehicle 310 attempts to minimize the deviation (the tracking error) and returns the vehicle 310 back closer to the planning layer path as the vehicle turns back towards its left.

Example Method for Trading Off Comfort with Other Factors

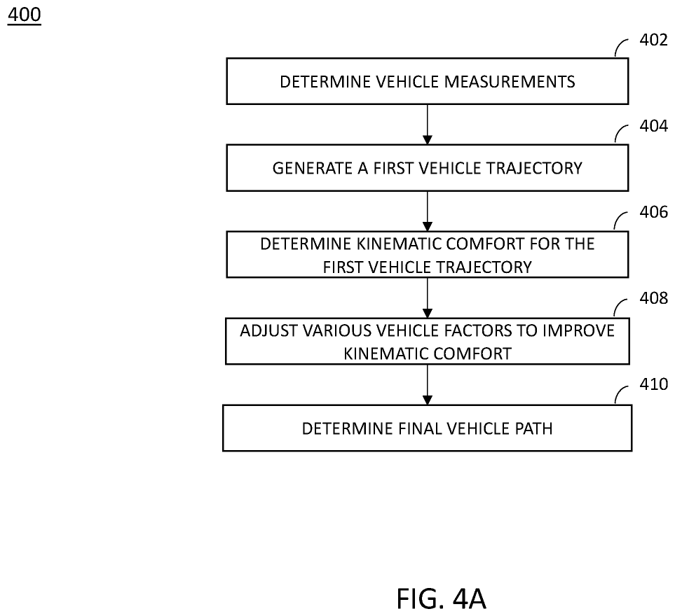

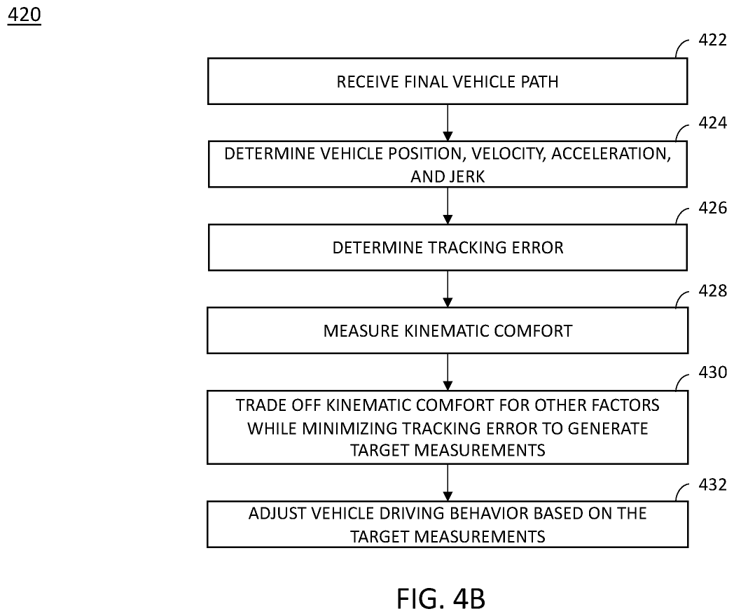

FIGS. 4A and 4B are flowcharts showing methods for trading off comfort with other factors in the planning layer and control layer, according to various examples of the present disclosure. FIG. 4A is a flowchart showing a method 400 for a planning layer to determine a vehicle path. At step 402, the planning layer determines vehicle measurements. This can include current vehicle measurements such as position, speed, velocity, acceleration, jerk, steering wheel angle, and other measurements. Measurements can include longitudinal acceleration, lateral acceleration, longitudinal jerk, lateral jerk, longitudinal velocity, and lateral velocity. Additionally, the vehicle measurements can include environmental data such as obstacles, other road users, pedestrians, traffic signs, traffic lights, lane lines, and other information about the vehicle surroundings. In some examples, the planning layer inputs include expected measurements over an upcoming period of time (i.e., over the next few seconds) or over an upcoming distance (i.e., over the next few meters).

Using these measurements, at step 404, the planning layer generates a first vehicle trajectory, which includes a path for the vehicle for an upcoming distance and/or time period. For example, the planning layer can generate a vehicle trajectory for the vehicle for the next meter, 5 meters, 10 meters, 20 meters, or more than 20 meters. Similarly, the planning layer can generate a vehicle trajectory for the next 2 seconds, 5 seconds, 10 seconds, or more than 10 seconds. The first vehicle trajectory includes a path for the vehicle, as well as vehicle speed, acceleration, jerk, braking, steering angle, and other vehicle factors.

At step 406, a kinematic comfort metric for the first vehicle trajectory is determined. The kinematic comfort metric can be based on frequency of acceleration, jerk, and/or other parameters. At step 408, various vehicle factors, such as acceleration and jerk are adjusted to improve the kinematic comfort metric. Note that adjusting acceleration and jerk automatically adjusts velocity, position, curvature, heading, and other measurements that are related to acceleration and jerk signals. In some examples, step 406 is performed concurrently with step 404, and kinematic comfort is considered while generating the vehicle driving factors. In some examples, at step 408, vehicle factors remain within selected limits, and kinematic comfort metrics are improved while trading off other measurements. For example, a vehicle may brake (i.e., decelerate) more slowly to improve kinematic comfort, but a minimal distance between the vehicle and other road users and obstacles is maintained. Additionally, in some examples, a minimal distance incorporates a comfortable distance, such that vehicle occupants are comfortable with the distance (i.e., the vehicle does not feel too close to other road users or obstacles). Additionally, for example, a very tight turn may be less comfortable for a vehicle occupant than a less tight turn, and a vehicle may take a turn more loosely and increase the kinematic comfort score. Similarly, a slower pace of deceleration can be more comfortable for a vehicle occupant than a hard brake, and deceleration can be adjusted to increase the kinematic comfort score. At step 410, a final vehicle path is determined. The final vehicle path determined at the planning layer is transmitted to a control layer.

FIG. 4B is a flowchart showing a method 420 for a control layer to adjust vehicle driving behavior, according to various examples of the present disclosure. At step 422, the control layer receives the final vehicle path from the planning layer. At step 424, the control layer determines vehicle measurements such as position, velocity, acceleration, and jerk. Measurements can include longitudinal acceleration, lateral acceleration, longitudinal jerk, lateral jerk, longitudinal velocity, and lateral velocity. According to various examples, the control layer has measurements for the exact vehicle state. The control layer receives current kinematic measurements of the vehicle and kinematic measurements for an upcoming period of time, such as the upcoming two two-five seconds. In some examples, the measurements over the time period are discretized at a selected sampling level.

At step 426, the control layer determines the tracking error. The tracking error indicates the difference between the final vehicle path received from the planning layer and the vehicle's actual path. In various examples, the control layer also determines tracking damping. In general, the control layer minimizes tracking error. At step 428, the control layer measures kinematic comfort. At step 430, using the kinematic comfort metric, the control layer can trade off kinematic comfort with other factors. In some examples, tracking error and tracking damping are other factors that can be adjusted. In general, the optimization minimizes a cost function that includes the comfort metric and tracking error. The goal of the optimization is to maximize comfort while minimizing tracking error, to maintain a reasonable comfort level for vehicle occupants. In particular, in some examples, tracking error may remain slightly higher than necessary in order to maintain the kinematic comfort metric within a selected range. In some examples, tracking error is maintained below a selected level (such that the vehicle tracks closely to the vehicle path) and kinematic comfort is maintained above a selected level (such that a certain level of comfort for occupants is provided). For example, a very tight turn may be less comfortable for a vehicle occupant than a less tight turn, and a vehicle may take a turn more loosely and increase the kinematic comfort score. Similarly, a slower pace of deceleration can be more comfortable for a vehicle occupant than a hard brake, and deceleration can be adjusted to increase the kinematic comfort score. At step 430, the control layer trades off various factors with kinematic comfort to generate target measurements for the vehicle. At step 432, the control layer adjusts vehicle driving behavior based on the target measurements.

### Example Autonomous Vehicle (AV) Management System

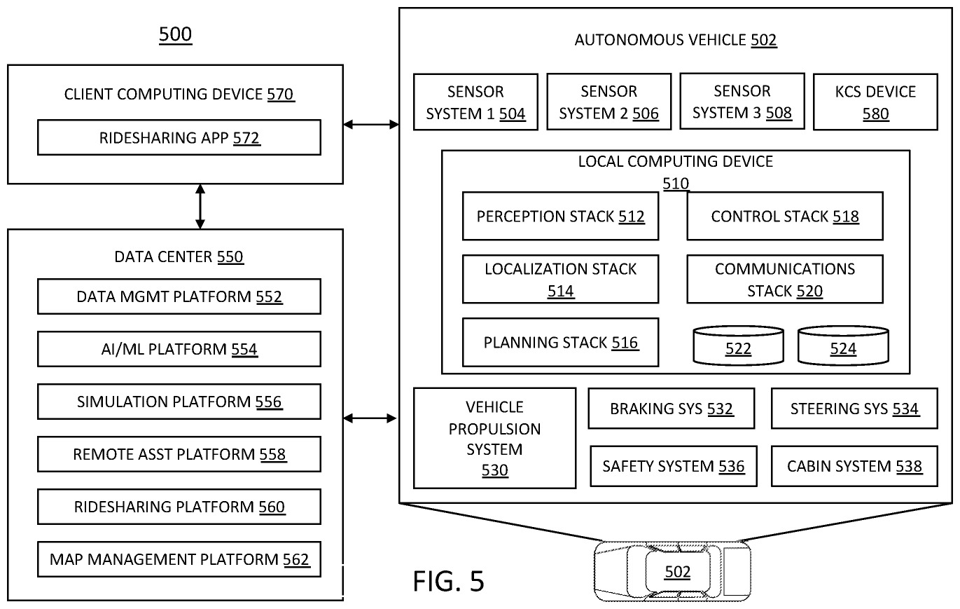

Turning now to FIG. 5, this figure illustrates an example of an AV management system 500. One of ordinary skill in the art will understand that, for the AV management system 500 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 500 includes an AV 502, a data center 550, and a client computing device 570. The AV 502, the data center 550, and the client computing device 570 can communicate with one another over one or more networks (not shown), such as a public network (e.g., the Internet, an Infrastructure as a Service (laaS) network, a Platform as a Service (PaaS) network, a Software as a Service (Saas) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 502 can navigate about roadways without a human driver based on sensor signals generated by multiple sensor systems 504, 506, and 508. The sensor systems 504-508 can include different types of sensors and can be arranged about the AV 502. For instance, the sensor systems 504-508 can comprise IMUs, cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., GPS receivers), audio sensors (e.g., microphones, SONAR systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 504 can be a camera system, the sensor system 506 can be a LIDAR system, and the sensor system 508 can be a RADAR system. Other embodiments may include any other number and type of sensors. In various examples, the sensor systems 504, 506, and/or 508 can be used to detect the proximity of another road user or NPC, and the proximity data can be used by the planning layer in determining planning a vehicle path as well as in calculating a comfort score for a ride.

The AV 502 can also include a kinematic comfort score device 580 for generating a kinematic comfort score for use by the planning 516 and control 518 stacks. In some examples, the comfort score device is part of the local computing device 510. In some examples, the comfort score module receives path and kinematic data from the planning stack 516 and/or the control stack 518 indicating measurements for a path and/or set of controls that have yet to be performed. The data can include lateral and longitudinal accelerometer data, to generate a kinematic comfort score.

AV 502 can also include several mechanical systems that can be used to maneuver or operate AV 502. For instance, the mechanical systems can include vehicle propulsion system 530, braking system 532, steering system 534, safety system 536, and cabin system 538, among other systems. Vehicle propulsion system 530 can include an electric motor, an internal combustion engine, or both. The braking system 532 can include an engine brake, a wheel braking system (e.g., a disc braking system that utilizes brake pads), hydraulics, actuators, and/or any other suitable componentry configured to assist in decelerating AV 502. The steering system 534 can include suitable componentry configured to control the direction of movement of the AV 502 during navigation. Safety system 536 can include lights and signal indicators, a parking brake, airbags, and so forth. The cabin system 538 can include cabin temperature control systems, in-cabin entertainment systems, and so forth. In some embodiments, the AV 502 may not include human driver actuators (e.g., steering wheel, handbrake, foot brake pedal, foot accelerator pedal, turn signal lever, window wipers, etc.) for controlling the AV 502. Instead, the cabin system 538 can include one or more client interfaces (e.g., Graphical User Interfaces (GUIs), Voice User Interfaces (VUIs), etc.) for controlling certain aspects of the mechanical systems 530-538.

AV 502 can additionally include a local computing device 510 that is in communication with the sensor systems 504-508, the mechanical systems 530-538, the data center 550, and the client computing device 570, among other systems. The local computing device 510 can include one or more processors and memory, including instructions that can be executed by the one or more processors. The instructions can make up one or more software stacks or components responsible for controlling the AV 502; communicating with the data center 550, the client computing device 570, and other systems; receiving inputs from riders, passengers, and other entities within the AV's environment; logging metrics collected by the sensor systems 504-508; and so forth. In this example, the local computing device 510 includes a perception stack 512, a mapping and localization stack 514, a planning stack 516, a control stack 518, a communications stack 520, a High Definition (HD) geospatial database 522, and an AV operational database 524, among other stacks and systems.

Perception stack 512 can enable the AV 502 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 504-508, the mapping and localization stack 514, the HD geospatial database 522, other components of the AV, and other data sources (e.g., the data center 550, the client computing device 570, third-party data sources, etc.). The perception stack 512 can detect and classify objects and determine their current and predicted locations, speeds, directions, and the like. In addition, the perception stack 512 can determine the free space around the AV 502 (e.g., to maintain a safe distance from other objects, change lanes, park the AV, etc.). The perception stack 512 can also identify environmental uncertainties, such as where to look for moving objects, flag areas that may be obscured or blocked from view, and so forth.

Mapping and localization stack 514 can determine the AV's position and orientation (pose) using different methods from multiple systems (e.g., GPS, IMUs, cameras, LIDAR, RADAR, ultrasonic sensors, the HD geospatial database 522, etc.). For example, in some embodiments, the AV 502 can compare sensor data captured in real-time by the sensor systems 504-508 to data in the HD geospatial database 522 to determine its precise (e.g., accurate to the order of a few centimeters or less) position and orientation. The AV 502 can focus its search based on sensor data from one or more first sensor systems (e.g., GPS) by matching sensor data from one or more second sensor systems (e.g., LIDAR). If the mapping and localization information from one system is unavailable, the AV 502 can use mapping and localization information from a redundant system and/or from remote data sources.

The planning stack 516 can determine how to maneuver or operate the AV 502 safely and efficiently in its environment. For example, the planning stack 516 can receive the location, speed, and direction of the AV 502, geospatial data, data regarding objects sharing the road with the AV 502 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 502 from one point to another. The planning stack 516 can determine multiple sets of one or more mechanical operations that the AV 502 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 516 can select from multiple backup plans to carry out. For example, while preparing to change lanes to turn right at an intersection, another vehicle may aggressively cut into the destination lane, making the lane change unsafe. The planning stack 516 could have already determined an alternative plan for such an event, and upon its occurrence, help to direct the AV 502 to go around the block instead of blocking a current lane while waiting for an opening to change lanes. As described herein, the planning stack 516 can use kinematic comfort data and trade off comfort with various factors in determining a vehicle path.

The control stack 518 can manage the operation of the vehicle propulsion system 530, the braking system 532, the steering system 534, the safety system 536, and the cabin system 538. The control stack 518 can receive sensor signals from the sensor systems 504-508 as well as communicate with other stacks or components of the local computing device 510 or a remote system (e.g., the data center 550) to effectuate operation of the AV 502. For example, the control stack 518 can implement the final path or actions from the multiple paths or actions provided by the planning stack 516. This can involve turning the routes and decisions from the planning stack 516 into commands for the actuators that control the AV's steering, throttle, brake, and drive unit. In some examples, the control stack 518 receives the vehicle path from the planning stack 516 and manages the operation of the vehicle to minimize tracking error while following the vehicle path. Additionally, the control stack 518 uses kinematic comfort data to increase a kinematic comfort score while maintaining tracking error below a selected error margin.

The communication stack 520 can transmit and receive signals between the various stacks and other components of the AV 502 and between the AV 502, the data center 550, the client computing device 570, and other remote systems. The communication stack 520 can enable the local computing device 510 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 520 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), BLUETOOTH®, infrared, etc.).

The HD geospatial database 522 can store HD maps and related data of the streets upon which the AV 502 travels. In some embodiments, the HD maps and related data can comprise multiple layers, such as an areas layer, a lanes and boundaries layer, an intersections layer, a traffic control layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

The AV operational database 524 can store raw AV data generated by the sensor systems 504-508 and other components of the AV 502 and/or data received by the AV 502 from remote systems (e.g., the data center 550, the client computing device 570, etc.). In some embodiments, the raw AV data can include HD LIDAR point cloud data, image or video data, RADAR data, GPS data, and other sensor data that the data center 550 can use for creating or updating AV geospatial data as discussed further below with respect to FIG. 5 and elsewhere in the present disclosure.

The data center 550 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 550 can include one or more computing devices remote to the local computing device 510 for managing a fleet of AVs and AV-related services. For example, in addition to managing the AV 502, the data center 550 may also support a ridesharing service, a delivery service, a remote/roadside assistance service, street services (e.g., street mapping, street patrol, street cleaning, street metering, parking reservation, etc.), and the like.

The data center 550 can send and receive various signals to and from the AV 502 and the client computing device 570. These signals can include sensor data captured by the sensor systems 504-508, roadside assistance requests, software updates, ridesharing pick-up and drop-off instructions, and so forth. In this example, the data center 550 includes one or more of a data management platform 552, an Artificial Intelligence/Machine Learning (AI/ML) platform 554, a simulation platform 556, a remote assistance platform 558, a ridesharing platform 560, and a map management platform 562, among other systems.

Data management platform 552 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 550 can access data stored by the data management platform 552 to provide their respective services.

The AI/ML platform 554 can provide the infrastructure for training and evaluating machine learning algorithms for operating the AV 502, the simulation platform 556, the remote assistance platform 558, the ridesharing platform 560, the map management platform 562, and other platforms and systems. Using the AI/ML platform 554, data scientists can prepare data sets from the data management platform 552; select, design, and train machine learning models; evaluate, refine, and deploy the models; maintain, monitor, and retrain the models; and so on.

The simulation platform 556 can enable testing and validation of the algorithms, machine learning models, neural networks, and other development efforts for the AV 502, the remote assistance platform 558, the ridesharing platform 560, the map management platform 562, and other platforms and systems. The simulation platform 556 can replicate a variety of driving environments and/or reproduce real-world scenarios from data captured by the AV 502, including rendering geospatial information and road infrastructure (e.g., streets, lanes, crosswalks, traffic lights, stop signs, etc.) obtained from the map management platform 562; modeling the behavior of other vehicles, bicycles, pedestrians, and other dynamic elements; simulating inclement weather conditions, different traffic scenarios; and so on.

The remote assistance platform 558 can generate and transmit instructions regarding the operation of the AV 502. For example, in response to an output of the AI/ML platform 554 or other system of the data center 550, the remote assistance platform 558 can prepare instructions for one or more stacks or other components of the AV 502.

The ridesharing platform 560 can interact with a customer of a ridesharing service via a ridesharing application 572 executing on the client computing device 570. The client computing device 570 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 572. The client computing device 570 can be a customer's mobile computing device or a computing device integrated with the AV 502 (e.g., the local computing device 510). The ridesharing platform 560 can receive requests to be picked up or dropped off from the ridesharing application 572 and dispatch the AV 502 for the trip.

Map management platform 562 can provide a set of tools for the manipulation and management of geographic and spatial (geospatial) and related attribute data. The data management platform 552 can receive LIDAR point cloud data, image data (e.g., still image, video, etc.), RADAR data, GPS data, and other sensor data (e.g., raw data) from one or more AVs 502, Unmanned Aerial Vehicles (UAVs), satellites, third-party mapping services, and other sources of geospatially referenced data. The raw data can be processed, and map management platform 562 can render base representations (e.g., tiles (2D), bounding volumes (3D), etc.) of the AV geospatial data to enable users to view, query, label, edit, and otherwise interact with the data. Map management platform 562 can manage workflows and tasks for operating on the AV geospatial data. Map management platform 562 can control access to the AV geospatial data, including granting or limiting access to the AV geospatial data based on user-based, role-based, group-based, task-based, and other attribute-based access control mechanisms. Map management platform 562 can provide version control for the AV geospatial data, such as to track specific changes that (human or machine) map editors have made to the data and to revert changes when necessary. Map management platform 562 can administer release management of the AV geospatial data, including distributing suitable iterations of the data to different users, computing devices, AVs, and other consumers of HD maps. Map management platform 562 can provide analytics regarding the AV geospatial data and related data, such as to generate insights relating to the throughput and quality of mapping tasks.

In some embodiments, the map viewing services of map management platform 562 can be modularized and deployed as part of one or more of the platforms and systems of the data center 550. For example, the AI/ML platform 554 may incorporate the map viewing services for visualizing the effectiveness of various object detection or object classification models, the simulation platform 556 may incorporate the map viewing services for recreating and visualizing certain driving scenarios, the remote assistance platform 558 may incorporate the map viewing services for replaying traffic incidents to facilitate and coordinate aid, the ridesharing platform 560 may incorporate the map viewing services into the client application 572 to enable passengers to view the AV 502 in transit en route to a pick-up or drop-off location, and so on.

### Example Processing System

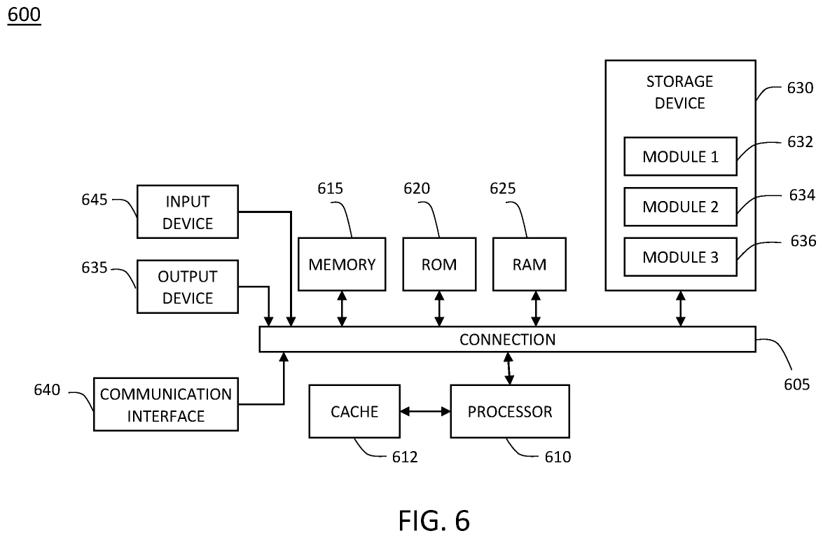

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as services 632, 634, and 636 stored in storage device 630, configured to control processor 610 as well as a special purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric. The services 632, 634, 636, can include software that interacts with planning and control stacks and generates a kinematic comfort metric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more GNSS receivers or transceivers that are used to determine a location of the computing system 600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer-readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid state memory, a Compact Disc (CD) Read-Only Memory (ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, RAM, Atatic RAM (SRAM), Dynamic RAM (DRAM), ROM, Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Example 1 provides a method for using a ride comfort index in generating a vehicle ride, comprising: receiving a target vehicle path; determining, at a vehicle control layer, a position measurement, a velocity measurement, and an acceleration measurement for the vehicle; determining a jerk measurement for the vehicle, wherein the jerk measurement is a derivative of the acceleration measurement; calculating a tracking error based on the position, velocity, acceleration, and jerk measurements, wherein the tracking error indicates a difference between the target vehicle path and an actual vehicle path; generating a kinematic comfort metric based on the acceleration and jerk measurements; generating target vehicle measurements by trading off the kinematic comfort metric with various vehicle factors to increase ride comfort while minimizing the tracking error; and adjusting vehicle driving behavior based on the target vehicle measurements.

Example 2 provides a method, system, and/or vehicle according to one or more of the preceding and/or following examples, wherein determining the acceleration measurement includes determining a frequency response of acceleration.

Example 3 provides a method, system, and/or vehicle according to one or more of the preceding and/or following examples, further comprising setting the acceleration measurement and the jerk measurement at a selected ratio.

Example 4 provides a method, system, and/or vehicle according to one or more of the preceding and/or following examples, wherein determining the acceleration measurement includes determining longitudinal acceleration and lateral acceleration, and wherein determining the jerk measurement includes determining longitudinal jerk and lateral jerk.

Example 5 provides a method, system, and/or vehicle according to one or more of the preceding and/or following examples, wherein the method is performed in a control layer, and wherein receiving the target vehicle path includes receiving a vehicle path reference from a planning layer.

Example 6 provides a method, system, and/or vehicle according to one or more of the preceding and/or following examples, wherein determining the position measurement, the velocity measurement, and the acceleration measurement includes determining the position measurement, the velocity measurement, and the acceleration measurement over a selected time period.

Example 7 provides a method, system, and/or vehicle according to one or more of the preceding and/or following examples, further comprising discretizing the position measurement, the velocity measurement, and the acceleration measurement at respective selected sampling frequencies over the selected time period.

Example 8 provides a method, system, and/or vehicle according to one or more of the preceding and/or following examples, wherein the selected time period includes a future time period.

Example 9 provides a method for using a ride comfort index in generating a vehicle path, comprising: determining, at a vehicle planning layer, a position measurement, a velocity measurement, and an acceleration measurement for the vehicle; determining a jerk measurement for the vehicle, wherein the jerk measurement is a derivative of the acceleration measurement; determining environmental vehicle measurements, wherein environmental vehicle measurements include obstacles and other road users; generating a first vehicle trajectory based on the measurements, wherein generating the first vehicle trajectory includes adjusting vehicle parameters; generating a kinematic comfort metric based on the acceleration and jerk measurements; adjusting various vehicle parameters to increase the kinematic comfort metric; and generating a final vehicle trajectory based on the adjusted vehicle parameters.

Example 10 provides a method, system, and/or vehicle according to one or more of the preceding and/or following examples, wherein the acceleration measurement includes a frequency response of acceleration.

Example 11 provides a method, system, and/or vehicle according to one or more of the preceding and/or following examples, wherein the acceleration measurement and the jerk measurement are set at a selected ratio.

Example 12 provides a method, system, and/or vehicle according to one or more of the preceding and/or following examples, wherein the acceleration measurement includes longitudinal acceleration and lateral acceleration, and wherein the jerk measurement includes longitudinal jerk and lateral jerk.

Example 13 provides a method, system, and/or vehicle according to one or more of the preceding and/or following examples, wherein the method is performed in a planning layer, and further comprising transmitting the final vehicle trajectory to a control layer.

Example 14 provides a method, system, and/or vehicle according to one or more of the preceding and/or following examples, wherein determining the position measurement, the velocity measurement, and the acceleration measurement includes determining the position measurement, the velocity measurement, and the acceleration measurement over a selected time period.

Example 15 provides a method, system, and/or vehicle according to one or more of the preceding and/or following examples, further comprising discretizing the position measurement, the velocity measurement, and the acceleration measurement at respective selected sampling frequencies over the selected time period.

Example 16 provides a vehicle for trading a ride comfort index with other factors in generating a vehicle ride, comprising: vehicle sensors to generate vehicle environment data; and an onboard computer for vehicle planning and control, including: a planning layer to generate a target vehicle path, and a control layer to: receive the target vehicle path; receive the position measurement, the velocity measurement, and the acceleration measurement; determine a jerk measurement, wherein the jerk measurement is a derivative of the acceleration measurement; calculate a tracking error based on the position, velocity, acceleration, and jerk measurements, wherein the tracking error indicates a difference between the target vehicle path and an actual vehicle path; generate a kinematic comfort metric based on the acceleration and jerk measurements; generate target vehicle measurements by trading off the kinematic comfort metric with various vehicle factors to increase ride comfort while minimizing the tracking error; and adjust vehicle driving behavior based on the target vehicle measurements.

Example 17 provides a method, system, and/or vehicle according to one or more of the preceding and/or following examples, wherein the vehicle sensors sense vehicle environment, wherein the onboard computer is to determine environmental measurements, wherein environmental measurements include obstacles and other road users, and wherein the planning layer is to generate the target vehicle path based in part on the environmental measurements.

Example 18 provides a method, system, and/or vehicle according to one or more of the preceding and/or following examples, wherein the acceleration measurement includes a frequency response of acceleration, wherein the acceleration measurement includes longitudinal acceleration and lateral acceleration, and wherein the jerk measurement includes longitudinal jerk and lateral jerk.

Example 19 provides a method, system, and/or vehicle according to one or more of the preceding and/or following examples, wherein the position measurement, the velocity measurement, and the acceleration measurement received at the control layer include are measurements from a selected time point, and wherein the control layer is to determine future position measurements, future velocity measurements, and future acceleration measurements over a selected time window.

Example 20 provides a method, system, and/or vehicle according to one or more of the preceding and/or following examples, wherein the control layer is to discretize the future position measurements, the future velocity measurements, and the future acceleration measurements at respective selected sampling frequencies over the selected time window.

Example 21 provides a computer-readable medium for performing the method of any of the examples 1-20.

Example 22 includes an apparatus comprising means for performing the method of any of the examples 1-21.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A method for using a ride comfort index in generating a vehicle ride, comprising:
receiving a target vehicle path;
determining, at a control layer, a position measurement, a velocity measurement, and an acceleration measurement for the vehicle;
determining a jerk measurement for the vehicle, wherein the jerk measurement is a derivative of the acceleration measurement;
calculating a tracking error based on the position, velocity, acceleration, and jerk measurements, wherein the tracking error indicates a difference between the target vehicle path and an actual vehicle path;
generating a kinematic comfort metric based on the acceleration and jerk measurements;
generating target vehicle measurements by trading off the kinematic comfort metric with various vehicle factors to maximize ride comfort and minimize the tracking error; and
adjusting vehicle driving behavior based on the target vehicle measurements.

2. The method of claim 1, wherein determining the acceleration measurement includes determining a frequency response of acceleration.

3. The method of claim 2, further comprising setting the acceleration measurement and the jerk measurement at a selected ratio.

4. The method of claim 2, wherein determining the acceleration measurement includes determining longitudinal acceleration and lateral acceleration, and wherein determining the jerk measurement includes determining longitudinal jerk and lateral jerk.

5. The method of claim 1, wherein the method is performed in a control layer, and wherein receiving the target vehicle path includes receiving a vehicle path reference from a planning layer.

6. The method of claim 1, wherein determining the position measurement, the velocity measurement, and the acceleration measurement includes determining the position measurement, the velocity measurement, and the acceleration measurement over a selected time period.

7. The method of claim 6, further comprising discretizing the position measurement, the velocity measurement, and the acceleration measurement at respective selected sampling frequencies over the selected time period.

8. The method of claim 7, wherein the selected time period includes a future time period.

9. A method for using a ride comfort index in generating a vehicle path, comprising:
determining, at a planning layer, a position measurement, a velocity measurement, and an acceleration measurement for the vehicle;
determining a jerk measurement for the vehicle, wherein the jerk measurement is a derivative of the acceleration measurement;
determining environmental vehicle measurements, wherein environmental vehicle measurements include obstacles and other road users;
generating a first vehicle trajectory based on the measurements, wherein generating the first vehicle trajectory includes adjusting vehicle parameters;
generating a kinematic comfort metric based on the acceleration and jerk measurements;
adjusting various vehicle parameters to increase the kinematic comfort metric; and
generating a final vehicle trajectory based on the adjusted vehicle parameters.

10. The method of claim 9, wherein determining the acceleration measurement includes determining a frequency response of acceleration.

11. The method of claim 10, further comprising setting the acceleration measurement and the jerk measurement at a selected ratio.

12. The method of claim 10, wherein determining the acceleration measurement includes determining longitudinal acceleration and lateral acceleration, and wherein determining the jerk measurement includes determining longitudinal jerk and lateral jerk.

13. The method of claim 9, wherein the method is performed in a planning layer, and further comprising transmitting the final vehicle trajectory to a control layer.

14. The method of claim 9, wherein determining the position measurement, the velocity measurement, and the acceleration measurement includes determining the position measurement, the velocity measurement, and the acceleration measurement over a selected time period.

15. The method of claim 14, further comprising discretizing the position measurement, the velocity measurement, and the acceleration measurement at respective selected sampling frequencies over the selected time period.

16. A vehicle for trading a ride comfort index with other factors in generating a vehicle ride, comprising:
vehicle sensors to generate vehicle sensor data including vehicle environment data; and
an onboard computer for vehicle planning and control, including:
a planning layer to generate a target vehicle path, and
a control layer to:
receive the target vehicle path;
determine a position measurement, a velocity measurement, and an acceleration measurement;
determine a jerk measurement, wherein the jerk measurement is a derivative of the acceleration measurement;
calculate a tracking error based on the position, velocity, acceleration, and jerk measurements, wherein the tracking error indicates a difference between the target vehicle path and an actual vehicle path;
generate a kinematic comfort metric based on the acceleration and jerk measurements;
generate target vehicle measurements by trading off the kinematic comfort metric with various vehicle factors to increase ride comfort while minimizing the tracking error; and
adjust vehicle driving behavior based on the target vehicle measurements.

17. The vehicle of claim 16, wherein the onboard computer is to determine environmental measurements based on the vehicle environment data, wherein environmental measurements include obstacles and other road users, and wherein the planning layer is to generate the target vehicle path based in part on the environmental measurements.

18. The vehicle of claim 16, wherein the acceleration measurement includes a frequency response of acceleration, wherein the acceleration measurement includes longitudinal acceleration and lateral acceleration, and wherein the jerk measurement includes longitudinal jerk and lateral jerk.

19. The vehicle of claim 16, wherein the position measurement, the velocity measurement, and the acceleration measurement determined by the control layer include measurements from a selected time point, and wherein the control layer is to determine future position measurements, future velocity measurements, and future acceleration measurements over a selected time window.

20. The vehicle of claim 16, wherein the control layer is to discretize the future position measurements, the future velocity measurements, and the future acceleration measurements at respective selected sampling frequencies over the selected time window.
